(19) United States
(12) Patent Application Publication
(10) Pub. No.: US 2014/0304249 A1
(43) Pub. Date: Oct. 9, 2014

(54) EXPERT DISCOVERY VIA SEARCH IN SHARED CONTENT

(71) Applicant: Evernote Corporation, Redwood City, CA (US)

(72) Inventors: Mark Ayzenshtat, San Mateo, CA (US); Zeesha Currimbhoy, Mountain View, CA (US)

(73) Assignee: Evernote Corporation, Redwood City, CA (US)

(21) Appl. No.: 14/190,304

(22) Filed: Feb. 26, 2014

Related U.S. Application Data
(60) Provisional application No. 61/808,287, filed on Apr. 4, 2013.

(51) Int. Cl. G06F 17/30

(52) U.S. Cl. CPC G06F 17/3053
USPC 707/709; 707/749

(57) ABSTRACT

Determining experts based on a search query of a user includes identifying items in a content collection that correspond to the search query, determining authors of the items, and ranking the authors according to relevance to the search query for each of the items for each of the authors. Determining experts based on a search query of a user may also include complementing the query with additional public search results prior to identifying the items. Complementing the query may include using an external data source to search based on the query. The external data source may be selected from the group consisting of Google Search, Yahoo Search, and Microsoft Bing. Determining experts based on a search query of a user may also include presenting the authors to the user in order of ranking The query may be a natural language query.

### CROSS-REFERENCE TO RELATED APPLICATIONS

This application claims priority to U.S. Prov. App. No. 61/808,287, filed Apr. 4, 2013, and entitled “EXPERT DISCOVERY VIA SEARCH IN SHARED CONTENT,” which is incorporated herein by reference.

### TECHNICAL FIELD

This application is directed to the field of information processing and analysis in content management systems, and more particularly to the field of identifying top content contributors in conjunction with advanced search in shared content collections.

### BACKGROUND OF THE INVENTION

Efficient search for content and documents has long become an important productivity factor for the worldwide workforce. According to recent research data, knowledge workers spend about 38% of their time searching for information. High search intensity by professionals in many industries shows its importance for productive work and is challenged by the findings of a global survey of information workers and IT professionals, which has discovered that, on average, almost half of the approximately five hours per week spent by knowledge workers searching for documents is wasted, because workers are not finding needed documents or other answers to their questions.

With the rise of cloud-based multi-platform enterprise content management systems (such as the Evernote service and software developed by the Evernote Corporation of Redwood City, California), large and highly diversified content collections shared within a business are becoming ubiquitous. Employees gain access to company-wide content created by different departments and individuals; the content covers different subjects, projects and knowledge areas, such as technology, production, product management, marketing, sales, quality assurance, customer support, human resources, employee benefits and corporate guidance, finance, applications, agreements, etc.

Materials are published in the content management systems in different formats; the materials may possess various attributes and editing histories and may be subject to layered access policies and restrictions. For example, information on employee compensation may be accessible only by a top management and part of a human resources department, while a specification for a confidential strategic project may be available only to executives and to the project team, but not to other teams and departments.

Searching and navigating such dynamic content collections with possible access restrictions may be challenging even for long-term employees or members of an organization. New employees who have not yet developed custom search skills and have not accumulated a company specific thesaurus and workflows for efficient search in vast content collections may need both on-board training and expert advice to efficiently perform their jobs. The challenge of efficient corporate search is further exacerbated by the rapid growth and fast pace of changes in dynamic companies, where both the necessity in identifying experts in different areas and the list of experts quickly evolve along with company development.

Traditional methods of expert discovery and rating used in public systems, such as Yahoo! Answers or Stack Overflow, may be poorly suited for corporate expert identification systems. Thus, experts in community question answering services are expected to be explicitly and actively engaged in answering user questions. The ranking of experts in such systems is often tied to characteristics such as question answering performance, dynamics of the answer set, and user satisfaction with previous results by the same expert. In contrast, internal company experts are typically engaged in their day-to-day work and their job responsibilities rarely include an explicit duty to provide expert advice to other employees.

Similarly, known automatic and semi-automatic methods for ranking online authorities based on web topology and associated link analysis in interconnected page structures may have limited applicability to corporate content management systems for a variety of reasons. Data interlinking in company-wide content collections may not be ubiquitous, links may be heterogeneous, and many links may be external, such as links from portions of web pages resulting from web clipping into a content collection. Additionally, many of the links may be hidden within attached documents, which may additionally complicate discovery of the links. Another challenge for expert discovery is the above-mentioned dynamic changes in expert groups: new employees with substantial knowledge in certain areas may not have sufficient contributions to corporate content collections at the start of their new careers and may be missed by data processing methods analyzing present enterprise content collections.

It should also be noted that methods for identifying experts and authorities in publicly available online services aren't adequately addressing limitations caused by enterprise security, including restricted and layered access to data collections.

Accordingly, it is desirable to develop efficient mechanisms for discovering subject area experts within companies.

### SUMMARY OF THE INVENTION

According to the system described herein, determining experts based on a search query of a user includes identifying items in a content collection that correspond to the search query, determining authors of the items, and ranking the authors according to relevance to the search query for each of the items for each of the authors. Determining experts based on a search query of a user may also include identifying additional items in a supplemental content collection that correspond to the search query, determining additional authors of the additional items, and ranking the authors and the additional authors according to relevance to the search query for each of the items and each of the additional items for each of the authors and each of the additional authors. The content collection may be a private database and the supplemental content collection may be a public database. Determining experts based on a search query of a user may also include complementing the query with additional public search results prior to identifying the items. Complementing the query may include using an external data source to search based on the query. The external data source may be selected from the group consisting of Google Search, Yahoo Search, and Microsoft Bing. Determining experts based on a search query of a user may also include presenting the authors to the user in order of ranking The user may be provided with additional information indicating the basis of the ranking The additional information indicating the basis of the ranking may be shown to the user according to access privileges of the user. The query may be a natural language query. Identifying items in a content collection that correspond to the search query may be based on linguistic similarity. Linguistic similarity may vary according to a product of term frequency and inverse document frequency of terms in the query and an item. Ranking the authors may include evaluating an amount of contribution of an item and relevance of the item to the query. Evaluating an amount of contribution may include providing different weights to different portions of items of the collection. The different portions may include a title, a main content portion, and tags.

According further to the system described herein, computer software, provided in a non-transitory computer-readable medium, determines experts based on a search query of a user. The software includes executable code that identifies items in a content collection that correspond to the search query, executable code that determines authors of the items, and executable code that ranks the authors according to relevance to the search query for each of the items for each of the authors. The software may also include executable code that identifies additional items in a supplemental content collection that correspond to the search query, executable code that determines additional authors of the additional items, and executable code that ranks the authors and the additional authors according to relevance to the search query for each of the items and each of the additional items for each of the authors and each of the additional authors. The content collection may be a private database and the supplemental content collection may be a public database. The software may also include executable code that complements the query with additional public search results prior to identifying the items. Complementing the query may include using an external data source to search based on the query. The external data source may be selected from the group consisting of Google Search, Yahoo Search, and Microsoft Bing. The software may also include executable code that presents the authors to the user in order of ranking The user may be provided with additional information indicating the basis of the ranking The additional information indicating the basis of the ranking may be shown to the user according to access privileges of the user. The query may be a natural language query. Executable code that identifies items in a content collection that correspond to the search query may use linguistic similarity. Linguistic similarity may vary according to a product of term frequency and inverse document frequency of terms in the query and an item. Executable code that ranks the authors may evaluate an amount of contribution of an item and relevance of the item to the query. Evaluating an amount of contribution may include providing different weights to different portions of items of the collection. The different portions may include a title, a main content portion, and tags.

The proposed method and system process a user search query to identify items in content collections related to an expanded search query, rank authors of related content items related by their contributions to the material and suggest a list of subject area experts to the user based on such rankings

The system takes as an input a user search query and processes the user search query in several steps:
The user search query may be complemented by public search results.
Related content items from company-wide data collections may be identified.
Content, composition and history of creation and updates of each related item may be analyzed from the standpoint of individual contributions of different authors to the content.
Authors may be ranked by their contribution to the whole set of related content items, weighted by the relevance of each item.
An ordered list of top authors is presented to the user.

In some embodiments, several additions and modifications to the above core process may be offered, for example:
The system may start with a natural language search query and extract search keywords from the original query.
The system may use external data sources to augment original content collections and expand the scope of the search, which may be especially helpful to extend expert rankings to new employees with substantial knowledge of various subject areas that may not be reflected in the corporate content collection because of short working period but may be present in other available publications by those employees, such as their LinkedIn pages, blogs, personal websites, etc.
The system may track its rankings and give the user an explanation of contributions of different authors to the related content; this may enable the user to fine tune the final choice of an expert or an expert group.
The system may take into account existing corporate access limitations and policies both at an expert identification phase and at a tracking and explanation phase. Thus, related content items that have been taken in consideration during expert identification phase but to which the user does not have access may be omitted or only partially presented in the explanations, as explained in more detail elsewhere herein.

After retrieving search terms from the original user query (whether the whole query or portion extracted from a natural language search phrase), the system may expand the query by submitting the original search terms to a general purpose search engine(s) such as Google Search, Yahoo Search or Microsoft Bing, using well-known communication protocols and APIs. Subsequently, top search results returned by a public engine, for example, top ten snippets of unsponsored search results appearing on the first search page, may be pre-processed as follows:
Common terms and other stop words, web links and non-textual content may be filtered out from search snippets.
The rest may be merged into a single expanded query

This expands the scope of search in the company-wide content collections by applying an intelligence of general purpose search engines. Internal search may prioritize found terms from the original search query over the acquired terms from the expanded query.

Related content items may be extracted from enterprise content collections based on various relevance metrics, such as a linguistic similarity between an expanded query or an original query and a content item from the collections. Relevance metrics may also be stratified between various parts and attributes of a content item, such as a title, main text, assigned tags, locations, attachments, etc. of a content item. Each such part or attribute may be treated as a criterion in a multi-criteria task; fractional relevance with respect to a given criterion may be defined as a conventional similarity metrics between two vectors of tf*idf values (term frequency multiplied by inverse document frequency values). The first vector is built for the input query (original or expanded) and the second vector is constructed for the current content item, where the coordinate set of the two vectors reflects joint terms present in the query and the item. Subsequently, fractional relevance values may be aggregated using relative importance of different criteria represented as weights or otherwise, as described in U.S. patent application Ser. No. 13/852,283 titled: “RELATED NOTES AND MULTI-LAYER SEARCH IN PERSONAL AND SHARED CONTENT”, filed on Mar. 28, 2013 by Ayzenshtat, et al. and incorporated by reference herein. Content items may be ranked according to aggregated relevance values of the content items and a list of top ranked content items may be selected for further analysis, hereinafter referred to as related items.

At a next step, a catalog of authors of all related items may be built and each author may be linked to every related item to which the author contributed, resulting in a content/author bipartite graph where edges are drawn between contributors and related items. Author contributions to a content item may include an original creation of the item as a web or document clip, typed or handwritten text, audio recording, photographed or scanned image, contact information, calendar entry, attached file(s) or any combination of the above, as well as a subsequent modification of the item by adding, deleting or editing content, assigning tags or reminders, moving or copying the item between content collections (such as Evernote notebooks), sharing the item in different ways and formats, merging the item with other items, etc. A quantitative estimate of contribution of an author to each content creation and sharing activity may be calculated based on a size of involved changes, partial relevance of the changes to an original or expanded search query, and an expertise level assigned to an activity. An expertise level may depend on a volume of added/modified content, as in the case of entering an original typed content, a drawing or a chart, or may be independent of such volume, which may occur, for example, when an original note has been created by clipping of a portion of a web page, which may reflect, under circumstances, a higher expertise level than in case of clipping a whole web page.

The sum of expertise levels for all edits of an author and other activities applied to a given content item, with due respect to relevance levels of the involved modified (added, deleted, edited) content fragments, may be considered a measure of contribution of an author to that item.

After the initial weights of individual edges of the content/author graph have been calculated as author contributions, a weighted sum of such contributions made by an author to different related items may be calculated, where relevance counts of different related items may be regarded as weights. The resulting value may determine an overall contribution of an author to a search query. The resulting value for an author correlates with the cumulative expertise level of the author with respect to the subject area expressed by the query. Authors with top expertise levels may be recommended to the user as experts in a knowledge area represented by the initial query.

As explained elsewhere herein, a company may possess expertise on top of direct, immediately measurable proficiency of content authors accumulated in the existing content collections. For example, a past work history may hint at an expertise in different areas but a new employee with a rich work experience may lack a significant contribution to the corporate content. To address such additional expert opportunities, the system may boost the initial content by compiling, for example, social networking profiles of employees in a separate collection. Alternatively, the system may keep a list of recent employees who have not yet contributed to company-wide content collections and search directly in social networks for materials authored by such employees, applying the procedure of expertise assessment to such additional materials to augment the initial expert list.

It should be noted that the system and method described herein are easily adaptable to layered corporate security and allow customized explanations of expert ratings to a user, subject to content access restrictions. At a lowest level of details, the user may receive an ordered list of experts with contact data and rankings, without any information on the expert selection process. At a highest level of detail, the user may receive a content/author graph constructed by the system for the initial and expanded query, with a breakdown of each a contribution of each author to each related content item, where only a permitted portion of related items and ties between authors and the content may be presented, while the protected part of content not accessible by the user may be completely hidden, obfuscated or grouped, for example, into “other relevant items” and/or “other relevant contributions” group(s).

### BRIEF DESCRIPTION OF THE DRAWINGS

Embodiments of the system described herein will now be explained in more detail in accordance with the figures of the drawings, which are briefly described as follows.

FIG. 1 is a schematic illustration of a system functional chart, according to embodiments of the system described herein.

FIG. 2 schematically illustrates relevance estimates and an associated selection of related content items, according to embodiments of the system described herein.

FIG. 3 is a schematic illustration of expertise assessment for a fragment of a content/author graph, according to embodiments of the system described herein.

FIG. 4 is a schematic illustration of an expert list and accompanying explanations of expert rankings, according to embodiments of the system described herein.

FIG. 5 is a system flow diagram, according to embodiments of the system described herein.

### DETAILED DESCRIPTION OF VARIOUS EMBODIMENTS

The system described herein provides a mechanism for expert discovery by users based on search by the users in corporate content collections. The system expands the context of a query of a user, finds related items in the corporate content, assesses contribution by different authors to the content containing related items and supplies the user with a list of experts on a subject matter chosen from most prominent contributors.

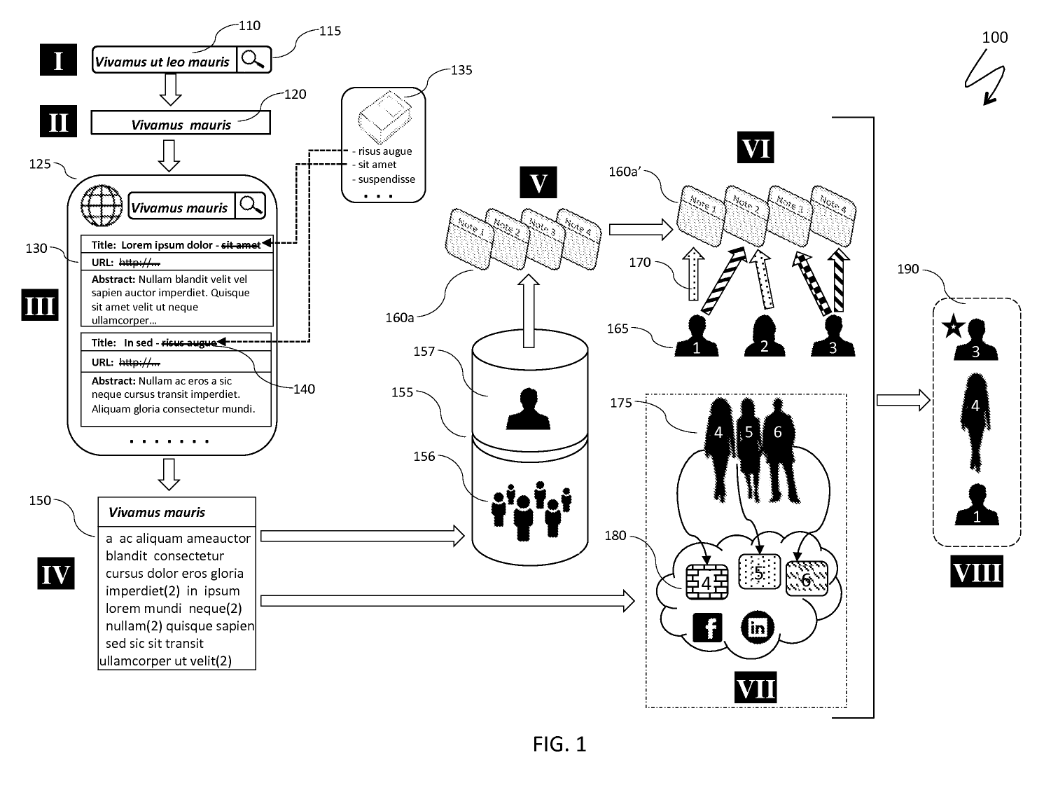

FIG. 1 is a schematic illustration 100 of a functional chart. System functioning is presented in FIG. 1 as a sequence of eight steps I-VIII. At the step I, a search term 110 is entered into a search field 115, which is part of a user interface of an enterprise content management system with which the system described herein is functioning. In an embodiment illustrated in FIG. 1, the initial search term 110 is a natural language query. At the step II, the system extracts substantial search keywords 120 from the term 110, thus forming a modified query. At the next step III, the system expands the modified query by submitting the modified query to a public search engine 125. Snippets of top search results 130 may be pre-processed by the system. URLs (web links) may be deleted from the snippets. Frequent words and other stop words may also be eliminated from the snippet using a system vocabulary 135 (which may be different for different languages and/or different contexts); an example of a deleted fictitious frequent term 140 illustrates a snippet cleaning process described herein. At the subsequent step IV, refined search snippets may be merged together and combined with the modified query to form an expanded query 150. As an example, words in the combined snippet may be arranged alphabetically, without repetitions and with frequency counts; higher counts may speak in favor of higher relevance of a corresponding word and may be taken into account by a relevance assessment mechanism explained elsewhere herein.

The expanded query 150 may be used in two different scenarios, which are illustrated by the steps V-VI (main scenario) and the step VII (optional additional scenario). At the step V, the expanded query may be compared with content items (notes, documents) of an enterprise or organization-wide content management system 155, which may combine shared and company-wide content collections 156 with individual content collection that may be fully or partially open for company-wide searches 157. Related items 160a may be identified using relevance metrics, as explained elsewhere herein. At the step VI, all original authors and contributors 165 to related items 160a′ (the related items 160a redrawn in a new place in the chart) may be identified and a bipartite content/author graph (160a′, 165, 170) with a set of nodes 160a′, 165 and a set of edges 170 may be constructed. A score of each edge may be calculated based on specific contributions, relevance of the contributions, and corresponding expertise levels, as explained in details elsewhere herein. Differences in edge scores are represented in FIG. 1 by different filling patterns of the edges-arrows 170. Subsequently, a summary expertise level of each expert with respect to a knowledge area or a subject matter, as represented by the expanded query, may be computed as a weighted sum of edge scores corresponding to different contributions, made by an expert to related content items; weights may be associated with relevance values of the related items.

At a parallel step VII, a group 175 of potential additional experts who may not have contributed sufficiently to the content collections 155 because of short employment or membership term for the potential additional experts, or for other reasons, may be evaluated using different sources. In FIG. 1, public online profiles and publications 180 of members of the group 175 are viewed as content items of an additional content collection (in some embodiments, the online profiles and publications 180 may be incorporated into the main content management system 155). Correspondingly, expertise levels within the group 175 with respect to the expanded query 150 may be assessed using similar techniques as those illustrated in connection with the steps V, VI.

At the step VIII, contributors may be ranked by cumulative expertise levels with respect to the expanded query 150 calculated at the step VI and, optionally, at the step VII. A list of top experts 190 is presented to the user in the order of rankings, with contact data for experts and, if required and available, with explanations of the contributions of the experts to related content items. The user may subsequently contact experts for an advice.

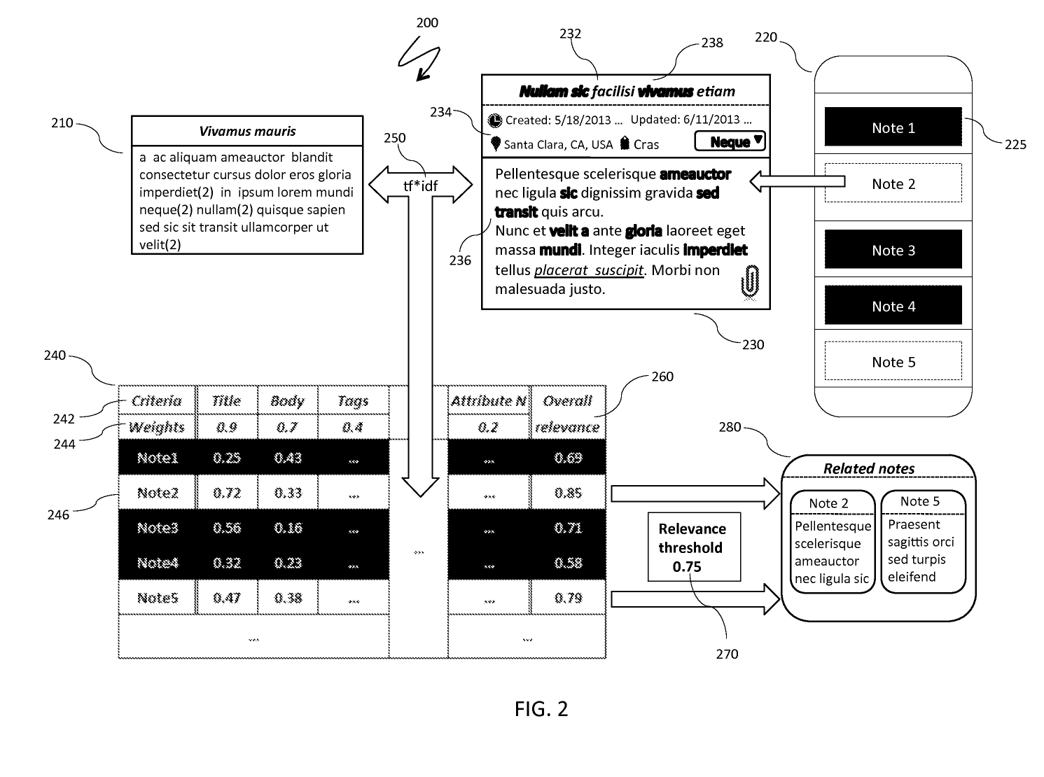

FIG. 2 is a schematic illustration 200 of relevance estimates and an associated selection of related content items. An expanded query 210 is compared with content items of a content collection 220, which are (in FIG. 2) interpreted as notes shown within the content collection in a collapsed form 225. Each note 230, expanded in FIG. 2 for illustration purposes, may have different parts and possess various attributes, for example, a title 232, a header 234, a body 236 with text, multimedia or other content, single or multiple tags, a destination content collection, a creation and last update time, a location (all shown in the header 234), one or several attachments, etc. Different parts and attributes may have different priorities for relevance estimation. Thus, a user assigned note title may carry a higher relevance weight than a body of the same note.

The system may choose related items based on an occurrence of terms from an expanded query 210 in different parts or in different attributes of the note 230. All such occurrences are shown in the note 230 in a bold outline font with an increased spacing between characters, as shown by an explication 238. Thus, a term “vivamus” of the original query is present in the title 232 of the note 230; additionally, two more terms from the expanded query, “nullam” and “sic”, can also be found in the title 232. The note body 236 includes nine terms from the expanded query.

Calculating numeric relevance estimates between a note and an expanded query may be illustrated by a note/criteria matrix 240. A top row 242 of the matrix 240 is a linear list of criteria that correspond to different parts and attributes of notes, such as, for example, a note title, a note body and assigned tag(s). The second row 244 of the matrix 240 shows weights assigned by the system to each criterion; in some embodiments, weights may be customized by users in system settings. Subsequent rows 246 of the matrix correspond to the notes; each row has relevance values corresponding to a note and a criterion in the central part of the matrix. It should be noted that, in embodiments, matrix columns corresponding to the criteria may reflect separately an original and an expanded query, which may nearly double the number of columns.

A note relevance value for a particular criterion may be calculated as a commonly accepted similarity metrics, such as a cosine similarity, between two vectors of tf*idf values 250, corresponding to the query and a note, as explained in more detail in U.S. patent application Ser. No. 13/852,283 titled: “RELATED NOTES AND MULTI-LAYER SEARCH IN PERSONAL AND SHARED CONTENT”, filed on Mar. 28, 2013 by Ayzenshtat, et al. and incorporated by reference herein. Once the matrix of partial relevance values have been obtained, a resulting column of the overall relevance values 260 may be calculated as a weighted sum of partial relevance values with weights 244. Using a relevance threshold 270, the system may choose a set of related notes 280, which includes all notes for which the overall relevance exceeds the threshold.

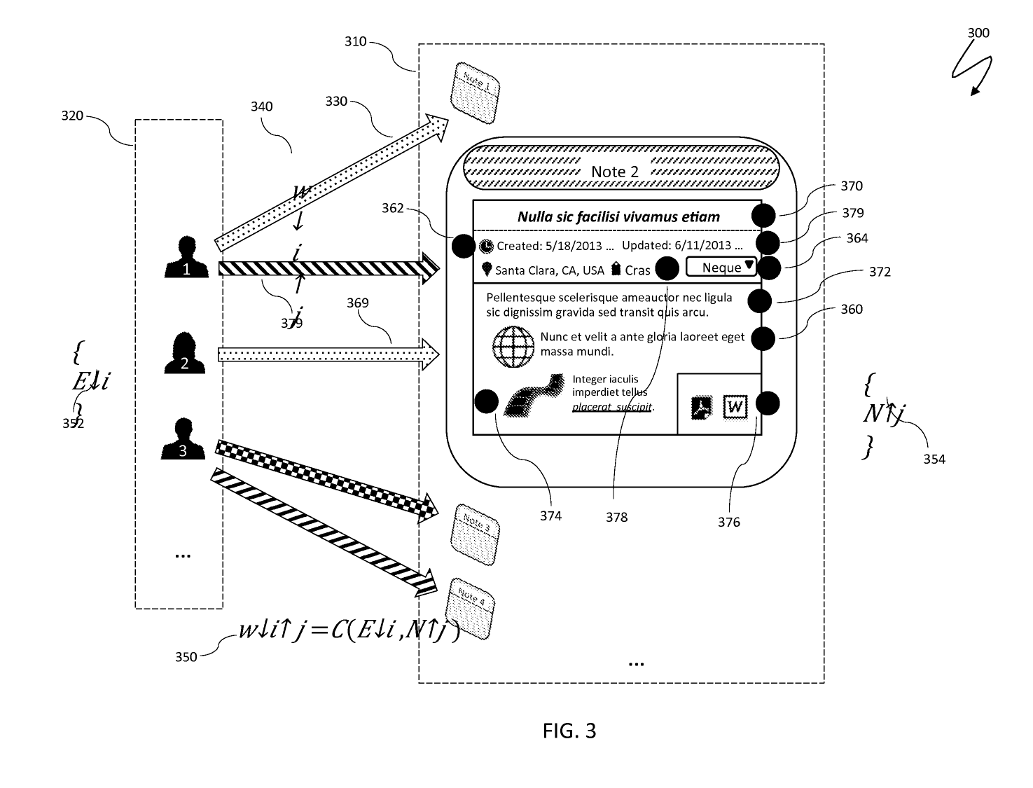

FIG. 3 is a schematic illustration 300 of an expertise assessment for a fragment of a content/author graph. A subset of four relevant notes 310, denoted for the purpose of this illustration as Note 1, . . . , Note 4, is coupled with a set of three authors 320, indicated as authors 1, 2, 3, to form a bipartite graph. Edges 330 of the graph connect each author with all notes from the shown subsets to which the said author has contributed. Values of contributions depend on multiple parameters, as explained elsewhere herein; full contribution of an author to a note is represented as a weight 340 of a graph edge 330. In FIG. 1, higher weights are illustrated by denser and bolder filling patterns of edges-arrows 330. An equation 350 for calculating weights as a function of authors 352 and notes 354 offers a more formal explanation of the process.

Furthermore, an illustration 300 explains in more details contributions of author 1 and author 2 to a Note 2. Fragments of the note corresponding to contributions of each author are marked with black circles corresponding to author numbers. Item numbers corresponding to the author 2 form the range 360-364, while contributions by the author 1 are in the range 370-379. The illustration shows that author 2 has initially created Note 2 as a web clip 360 on a date 362 and placed the initial note into a notebook 364. Afterwards, author 1 has assigned a new title 370 to Note 2, added a portion of text 372, added an embedded video clip with a description 374 and two attachments 376, and also assigned a tag 378 to Note 2, so the latest modification date 379 for Note 2 is after a creation date for Note 2. By estimating and summarizing contributions of the two authors to the note, as explained elsewhere herein, the system may determine substantially different note weights 369, 379, which show a more significant contribution and expertise level of author 1 with respect to Note 2.

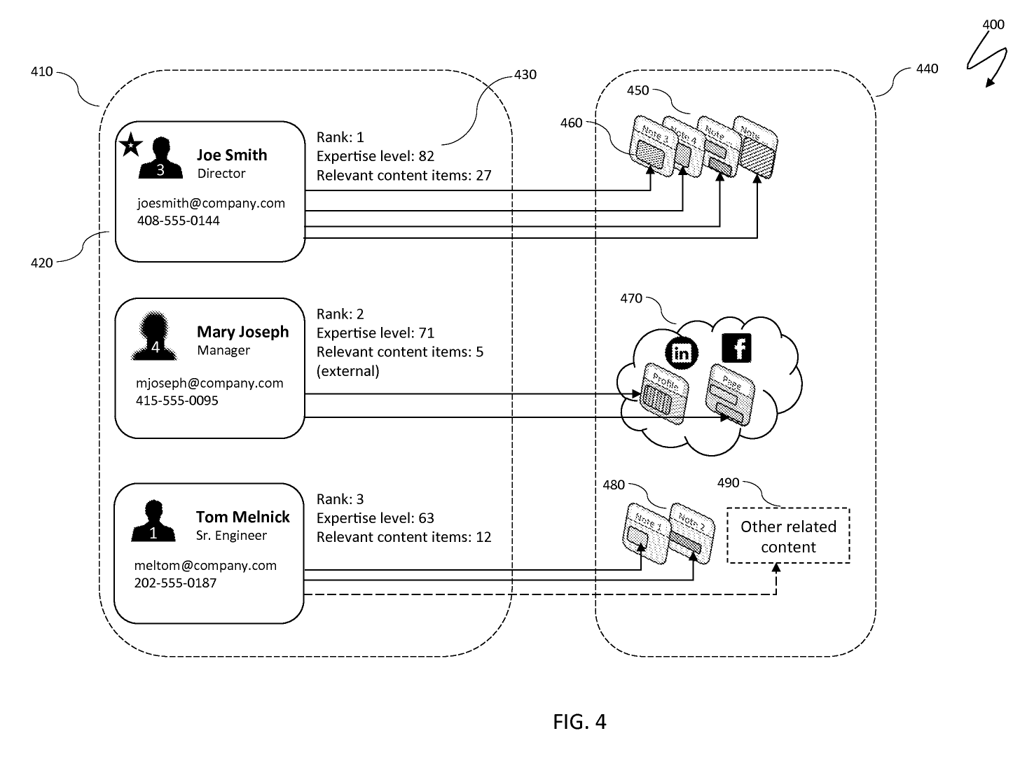

FIG. 4 is a schematic illustration 400 of an expert list and accompanying explanations of expert rating. An expert list 410 includes three candidates, author 3, author 4, and author 1, with contact information 420 and a summary of ranking 430 for each expert (explicitly enumerated only for author 3). By user request, an explanation 440 of ratings may be displayed with a detailed date if there is not a conflict with user access permissions. In FIG. 4, the structure of explanations differs from expert to expert as follows:
For the top expert, author 3, a full set of related notes 450 to which the expert has contributed is presented to the user; specific contributions of the author are shown as fragments 460; filling patterns correspond to varying levels of relevance and expertise for the fragments 460.
The next expert, author 4, has not contributed to the main content management system and expertise of the author is assessed on the basis of online materials 470, such as profiles and publications on social networks, including LinkedIn and Facebook. Contributions of a next expert, author 1, include a portion 480 of related notes accessible by the user where contributions of the expert are highlighted; contributions of author 1 also include a portion 490 of related notes to which user access is prohibited and it is shown as other related content without details.

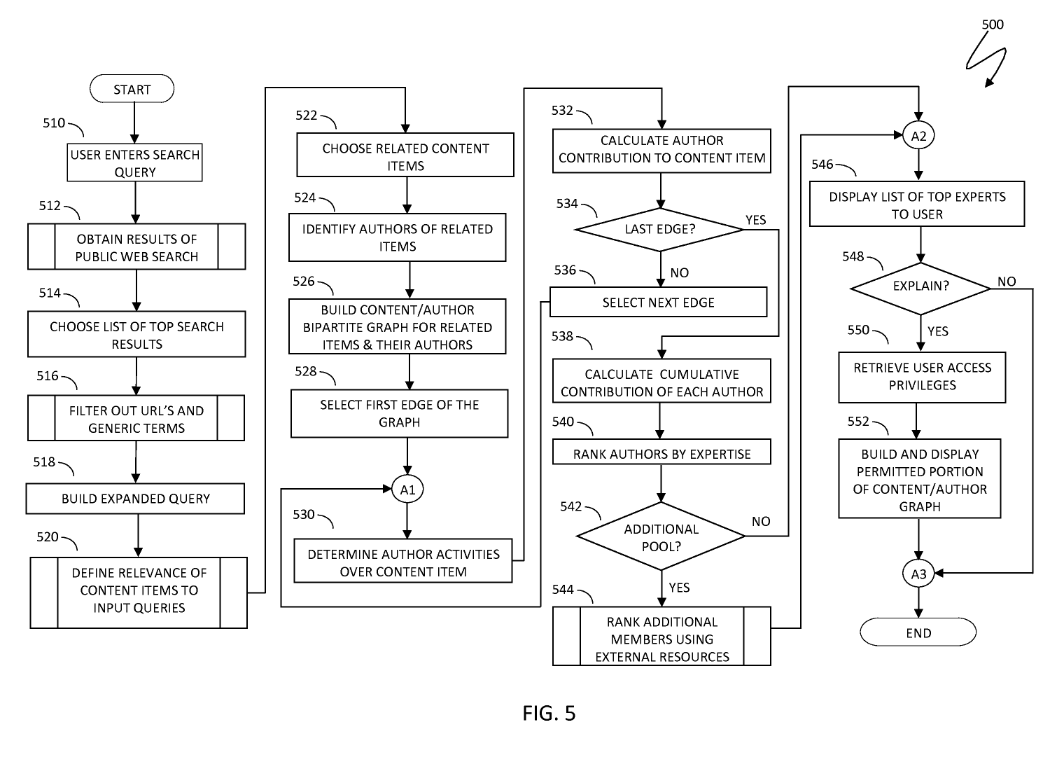

Referring to FIG. 5, a flow diagram 500 illustrates functioning of the system described herein. Processing starts at a step 510 where a user enters a search query. Note that in FIG. 5, an assumption is made that the original query is immediately entered, so the system does not need to extract search terms from a natural language or other descriptive query. After the step 510, processing proceeds to a step 512, where the system submits the original query to a public search engine and obtains results of public search. After the step 512, processing proceeds to a step 514, where the system forms a list of top search results, such as search snippets for the first ten items on the first page of search results, as explained elsewhere herein, in particular, in conjunction with the description text for FIG. 1.

After the step 514, processing proceeds to a step 516, where the system filters our URLs and generic terms from search results, as explained elsewhere herein, in particular, in conjunction with explaining the items 130, 135, 140 in FIG. 1. After the step 516, processing proceeds to a step 518, where an expanded query is built from refined search snippets. After the step 518, processing proceeds to a step 520, where the expanded query is compared with content items from company-wide content collections (and, optionally, with items from individual content collection that participate in company-wide search) and relevance of content items to user queries, original and expanded, is calculated, as explained elsewhere herein, in particular, in FIG. 2 and an accompanying description. After the step 520, processing proceeds to a step 522, where related content items are chosen based on relevance values and a cut-off threshold, as explained elsewhere herein, in particular, in FIG. 2 and an accompanying description.

After the step 522, processing proceeds to a step 524, where authors of related items are identified, as explained elsewhere herein; see, in particular, FIGS. 1, 3 and accompanying descriptions. After the step 524, processing proceeds to a step 526, where a content/author bipartite graph is built for related items and their respective authors; see FIG. 3 and accompanying explanations. After the step 526, processing proceeds to a step 528, where the calculation of expertise levels begins with selecting a first edge of the graph (in any enumeration of edges associated with the graph definition in the step 526). The chosen edge defines a pair (author, related content item), where the author is known to contribute to the content item. After the step 528, processing proceeds to a step 530, where specific author activities over the content item for the selected edge of the graph are determined. After the step 530, processing proceeds to a step 532, where contribution of an author to the content item defined by the chosen edge is calculated, as explained elsewhere herein, in particular, in conjunction with FIG. 3 and the corresponding description.

After the step 532, processing proceeds to a test step 534, where it is determined whether the selected edge is the last edge of the content/author graph. If so, processing proceeds to a step 538; otherwise, processing proceeds to a step 536 where a next edge is selected and processing returns to the start of calculations for an edge of the graph at the step 530, which may be independently reached from the step 528. At the step 538, a cumulative contribution of each author is calculated as a weighted sum of contribution scores of that author for different related items, with due respect to relevance levels of the items, as explained elsewhere herein. Cumulative contribution scores of authors are associated with their expertise levels with respect to a knowledge area represented by a user query. After the step 538, processing proceeds to a step 540, where authors are ranked by expertise levels. After the step 540, processing proceeds to a test step 542, where it is determined whether an additional pool of potential experts exists in an organization, based on hiring dates, positions or other data, as explained elsewhere herein. If so, processing proceeds to a step 544; otherwise, processing proceeds to a step 546. At the step 544, additional members of an organization treated as potential experts are ranked by their expertise levels using external sources, as explained elsewhere herein; see, for example, step VII on FIG. 1 and a corresponding text herein.

After the step 544, processing proceed to the step 546, which may be independently reached from the step 542. At the step 546, a list of top experts is displayed to the user with contact data and basic ranking information of each expert; see, in particular, items 410, 420, 430 in FIG. 4 and the accompanying text. After the step 546, processing proceeds to a test step 548, where it is determined whether the user requests an explanation of choice and ranking of the experts. If not, processing is complete. Otherwise, processing proceeds to a step 550, where the system retrieves user access privileges. After the step 550, processing proceeds to a step 552, where the system tracks back author contribution values, builds and displays to the user a permitted portion and connections of the content/author graph, possibly highlighting each contribution of each expert to each related item, subject to access privileges of the user, as explained in more details elsewhere herein, in particular, by items 440-490 in FIG. 4 and in the corresponding descriptions. Following the step 552, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions.

Software implementations of the system described herein may include executable code that is stored in a computer readable medium and executed by one or more processors, including one or more processors of a desktop computer. The desktop computer may receive input from a capturing device that may be connected to, part of, or otherwise in communication with the desktop computer. The desktop computer may include software that is pre-loaded with the device, installed from an app store, installed from media such as a CD, DVD, etc., and/or downloaded from a Web site. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of determining experts based on a search query of a user, comprising:
identifying items in a content collection that correspond to the search query;
determining authors of the items; and
ranking the authors according to relevance to the search query for each of the items for each of the authors.

2. A method, according to claim 1, further comprising:
identifying additional items in a supplemental content collection that correspond to the search query;
determining additional authors of the additional items; and
ranking the authors and the additional authors according to relevance to the search query for each of the items and each of the additional items for each of the authors and each of the additional authors.

3. A method, according to claim 2, wherein the content collection is a private database and the supplemental content collection is a public database.

4. A method, according to claim 1, further comprising:
complementing the query with additional public search results prior to identifying the items.

5. A method, according to claim 4, wherein complementing the query includes using an external data source to search based on the query.

6. A method, according to claim 5, wherein the external data source is selected from the group consisting of Google Search, Yahoo Search, and Microsoft Bing.

7. A method, according to claim 1, further comprising:
presenting the authors to the user in order of ranking

8. A method, according to claim 7, wherein the user is provided with additional information indicating the basis of the ranking.

9. A method, according to claim 8, wherein the additional information indicating the basis of the ranking is shown to the user according to access privileges of the user.

10. A method, according to claim 1, wherein the query is a natural language query.

11. A method, according to claim 1, wherein identifying items in a content collection that correspond to the search query is based on linguistic similarity.

12. A method, according to claim 11, wherein linguistic similarity varies according to a product of term frequency and inverse document frequency of terms in the query and an item.

13. A method, according to claim 1, wherein ranking the authors includes evaluating an amount of contribution of an item and relevance of the item to the query.

14. A method, according to claim 13, wherein evaluating an amount of contribution includes providing different weights to different portions of items of the collection.

15. A method, according to claim 14, wherein the different portions include a title, a main content portion, and tags.

16. Computer software, provided in a non-transitory computer-readable medium, that determines experts based on a search query of a user, the software comprising:
executable code that identifies items in a content collection that correspond to the search query;
executable code that determines authors of the items; and
executable code that ranks the authors according to relevance to the search query for each of the items for each of the authors.

17. Computer software, according to claim 16, further comprising:
executable code that identifies additional items in a supplemental content collection that correspond to the search query;
executable code that determines additional authors of the additional items; and
executable code that ranks the authors and the additional authors according to relevance to the search query for each of the items and each of the additional items for each of the authors and each of the additional authors.

18. Computer software, according to claim 17, wherein the content collection is a private database and the supplemental content collection is a public database.

19. Computer software, according to claim 16, further comprising:
executable code that complements the query with additional public search results prior to identifying the items.

20. Computer software, according to claim 19, wherein complementing the query includes using an external data source to search based on the query.

21. Computer software, according to claim 20, wherein the external data source is selected from the group consisting of Google Search, Yahoo Search, and Microsoft Bing.

22. Computer software, according to claim 16, further comprising:
executable code that presents the authors to the user in order of ranking

23. Computer software, according to claim 22, wherein the user is provided with additional information indicating the basis of the ranking.

24. Computer software, according to claim 23, wherein the additional information indicating the basis of the ranking is shown to the user according to access privileges of the user.

25. Computer software, according to claim 16, wherein the query is a natural language query.

26. Computer software, according to claim 16, wherein executable code that identifies items in a content collection that correspond to the search query uses linguistic similarity.

27. Computer software, according to claim 26, wherein linguistic similarity varies according to a product of term frequency and inverse document frequency of terms in the query and an item.

28. Computer software, according to claim 16, wherein executable code that ranks the authors evaluates an amount of contribution of an item and relevance of the item to the query.

29. Computer software, according to claim 28, wherein evaluating an amount of contribution includes providing different weights to different portions of items of the collection.

30. Computer software, according to claim 29, wherein the different portions include a title, a main content portion, and tags.
